(19) United States
(12) Patent Application Publication
(10) Pub. No.: US 2010/0078197 A1
(43) Pub. Date: Apr. 1, 2010

(54) METAL NANOWIRES, METHOD FOR PRODUCING THE SAME, AND TRANSPARENT CONDUCTOR

(75) Inventors: NORI MIYAGISHIMA, KANAGAWA (JP); RYOJI NISHIMURA, KANAGAWA (JP); YOICHI HOSOYA, KANAGAWA (JP); TAKESHI FUNAKUBO, KANAGAWA (JP); KENJI NAOI, KANAGAWA (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/570,002

(22) Filed: Sep. 30, 2009

(30) Foreign Application Priority Data
Sep. 30, 2008 (JP) 2008-252707

(51) Int. Cl. H01B 5/08; H01B 5/00; B22F 9/00

(52) U.S. Cl. 174/128.1; 174/126.1; 75/330; 977/762; 977/895

(57) ABSTRACT

The present invention provides metal nanowires containing at least metal nanowires having a diameter of 50 nm or less and a major axis length of 5 μm or more in an amount of 50% by mass or more in terms of metal amount with respect to total metal particles.

### BACKGROUND OF THE INVENTION

1. Field of the Invention

The present invention relates to highly monodisperse metal nanowires which are improved in transparency, conductivity, and durability, a method for producing the same, and a transparent conductor using the same.

2. Description of the Related Art

Metal nanowires having a major axis length of 1 μm or more and a minor axis length of 100 nm or less, which are obtained by performing a polyol method, centrifuging, and replacing the solvent, are proposed (see U.S. Published Application Nos. 2005/0056118 and 2007/0074316).

Furthermore, nanowires having a major axis length of several tens of micrometers and a minor axis length of 28 nm to 50 nm, which are obtained by reducing a silver ammonia complex in a water solvent using an autoclave (at 120° C. for 8 hr), are reported (see J. Phys. Chem. B 2005, 109, 5497).

Furthermore, it is reported that silver nanowires having a major axis length of several micrometers and a minor axis length of 10 nm, which are produced through reaction for 70 min using a water solvent of 100° C., can be observed through purification by centrifugation (see Adv. Funct. Mater. 2004, 14, 183).

Furthermore, it is reported that monodisperse nanowires having a minor axis length of 100 nm are produced by reducing silver chloride using glucose in a water solvent (see Chem. Eur. J. 2005, 77, 160).

Moreover, silver nanowires having a minor axis length of 90 nm to 300 nm, which are obtained by immersing a glass substrate, on which copper fine particles have been electrolytically deposited, in an aqueous solution of silver nitrate overnight, are proposed (see Japanese Patent Application Laid-Open (JP-A) No. 2006-196923).

Such literature of the related art as mentioned above discloses metal nanowires having various minor axis lengths and major axis lengths. However, when metal nanowires do not contain a sufficient amount of metal nanowires each having a suitable diameter and length, or when metal nanowires have a polydisperse size distribution, a transparent conductive film containing such metal nanowires may be degraded in durability likely because of some voltage convergence. Further, when a cross-section of the metal nanowires has sharp corners, transparency may be degraded with yellowish coloring on the film, etc. likely because of increase in plasmon absorption caused by electrons being localized in such corners.

In order for metal nanowires to have high transparency, conductivity, and durability, it is desired that the metal nanowires contain, in a large amount, those having a minor axis length of 50 nm or less and a major axis length of 5 μm or more. Furthermore, it is desired that metal nanowires having a large minor axis length be improved in terms of their influence on transparency. On the other hand, it is desired that metal nanowires having a short major axis length be improved in terms of their influence on conductivity. Furthermore, it is desired that polydisperse metal nanowires be improved in terms of their influence on durability of transparent conductive film containing them. In order to further improve their effect on durability, it is desired that the metal nanowires have highly monodisperse size distribution.

However, at present, metal nanowires which solve all of these problems and meet all of these demands, a method for producing the same, and an aqueous dispersion or a transparent conductor using the same have not yet been provided, and their further improvement and development are desired.

### BRIEF SUMMARY OF THE INVENTION

An object of the present invention is to provide metal nanowires which can achieve both transparency, conductivity, and durability, a method for producing the same, and a transparent conductor using the same.

Means for solving the above problems are as follows:

<1> Metal nanowires containing at least metal nanowires having a diameter of 50 nm or less and a major axis length of 5 μm or more in an amount of 50% by mass or more in terms of metal amount with respect to total metal particles.
<2> The metal nanowires according to <1>, wherein the coefficient of variation of diameter of the metal nanowires is 40% or less.
<3> The metal nanowires according to <1>, wherein a cross-section of each of the metal nanowires has round corners.
<4> The metal nanowires according to <1>, wherein the metal nanowires contain silver.
<5> A method for producing metal nanowires, including at least adding a solution of a metal complex to a water solvent containing at least a halide and a reducing agent, and heating a resultant mixture at 150° C. or lower, wherein the metal nanowires are metal nanowires which contain at least metal nanowires having a diameter of 50 nm or less and a major axis length of 5 μm or more in an amount of 50% by mass or more in terms of metal amount with respect to total metal particles
<6> An aqueous dispersion containing at least metal nanowires, wherein the metal nanowires are metal nanowires which contain at least metal nanowires having a diameter of 50 nm or less and a major axis length of 5 μm or more in an amount of 50% by mass or more in terms of metal amount with respect to total metal particles.
<7> A transparent conductor containing at least a transparent conductive layer, wherein the transparent conductive layer contains metal nanowires which contain at least metal nanowires having a diameter of 50 nm or less and a major axis length of 5 μm or more in an amount of 50% by mass or more in terms of metal amount with respect to total metal particles.
<8> A touch panel containing at least a transparent conductor with a transparent conductive layer which contains metal nanowires which contain at least metal nanowires having a diameter of 50 nm or less and a major axis length of 5 μm or more in an amount of 50% by mass or more in terms of metal amount with respect to total metal particles.
<9> A solar battery panel containing at least a transparent conductor with a transparent conductive layer which contains metal nanowires which contain at least metal nanowires having a diameter of 50 nm or less and a major axis length of 5 μm or more in an amount of 50% by mass or more in terms of metal amount with respect to total metal particles.

According to the present invention, problems of the related art can be solved, as well as metal nanowires which can achieve both transparency, conductivity, and durability, a method for producing the same, and a transparent conductor using the same can be provided.

### BRIEF DESCRIPTION OF THE DRAWING

FIG. 1 is a schematic view for reference to illustration of a method of determining a degree of sharpness of cross-section's corners of a metal nanowire.

### DETAILED DESCRIPTION OF THE INVENTION

### Metal Nanowires

Metal nanowires according to the present invention contain at least metal nanowires having a diameter of 50 nm or less and a major axis length of 5 μm or more in an amount of 50% by mass or more in terms of metal amount with respect to total metal particles.

In the present invention, the metal nanowires mean metal fine particles having an aspect ratio (major axis length/diameter) of 30 or more.

The diameter (minor axis length) of the metal nanowires is 50 nm or less, preferably 35 nm or less, more preferably 20 nm or less. Since metal nanowires having an excessively small diameter may degrade in resistance to oxidation and durability, the diameter is preferably 5 nm or more. When the diameter is larger to than 50 nm, adequate transparency may not be obtained likely because of light scattering by the metal nanowires.

The major axis length of the metal nanowires is 5 μm or more, preferably 10 μm or more, and more preferably 30 μm or more. Since metal nanowires having an excessively long major axis length may cause aggregation of the metal nanowires in a production process likely because of tangling of the metal nanowires in the production process, the major axis length is preferably 1 mm or less. When the major axis length is less than 5 μm, adequate conductivity may not be obtained likely because of difficulty in forming a dense network.

Here, the diameter and the major axis length of the metal nanowires can be determined, for example, from a TEM image or an optical microscope image obtained by means of a transmission electron microscope (TEM) or an optical microscope. In the present invention, the diameter and the major axis length of the metal nanowires are, respectively, a mean of diameters and a mean of major axis lengths of 300 metal nanowires observed under a transmission electron microscope (TEM).

In the present invention, the amount of metal nanowires having a diameter of 50 nm or less and a major axis length of 5 μm or more in total metal particles in terms of metal amount is 50% by mass or more, preferably 60% by mass or more, and more preferably 75% by mass or more.

When the amount of metal nanowires having a diameter of 50 nm or less and a major axis length of 5 μm or more in the total metal particles in terms of metal amount (hereinafter may be referred to as “rate of suitable wires”) is less than 50% by mass, the conductivity may be degraded likely because of reduction in amount of metal contributable to conductivity, as well as durability may be degraded likely because of some voltage convergence due to failure in forming a dense wire network. Furthermore, when some particles other than the nanowires are spherical in shape and have strong plasmon absorption, the transparency may be degraded.

Here, the total metal particles include metal nanorods and spherical metal particles in addition to metal nanowires.

Here, for example, when the metal nanowires are silver nanowires, the rate of suitable wires can be determined by a method in which the suitable silver nanowires in a water dispersion of the silver nanowires are separated from the other particles by filtration, and the amount of Ag remaining on the paper filter and the amount of Ag in the filtrate are each measured by means of an ICP atomic emission spectrometer. It is confirmed that metal nanowires remaining on the paper filter are metal nanowires having a diameter of 50 nm or less and a major axis length of 5 μm or more by observing diameters of 300 metal nanowires remaining on the paper filter through a TEM and by analyzing their distribution. Preferably, the paper filter may be able to filter the particles having a major axis length of 5 or more times of the maximum major axis length of the particles other than metal nanowires having a diameter of 50 nm or less and a major axis length of 5 μm or more and a minor axis length of half or less of the minimum major axis length of the particles other than the metal nanowires having a diameter of 50 nm or less and a major axis length of 5 μm or more.

The coefficient of variation of diameter of the metal nanowires of the present invention is preferably 40% or less, more preferably 35% or less, still more preferably 30% or less.

When the coefficient of variation of diameter of the metal nanowires is more than 40%, the durability may be degraded likely because of some voltage convergence on wires having a small diameter.

The coefficient of variation of diameter of the metal nanowires can be determined by calculating from the standard deviation and the mean of diameters of 300 nanowires measured using, for example, transmission electron microscopic (TEM) images of the nanowires.

The shape of the metal nanowires of the present invention may be any shape such as a cylindrical columnar shape, a rectangular parallelepiped shape, and a columnar shape with a polygonal cross-section. When high transparency is required in their use, the shape of the metal nanowires is preferably a cylindrical columnar shape or a columnar shape with a polygonal cross-section having round corners.

The shape of cross-section of the metal nanowires may be confirmed as follows. Specifically, a water dispersion of the metal nanowires is applied on a substrate, and their cross-sections are observed under a transmission electron microscope (TEM).

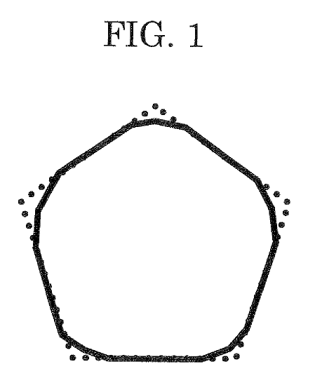

A corner of the cross-section of the metal nanowires means a part around an intersection point of the two extended straight lines from the neighboring sides of the cross-section. “Side of the cross-section” means a straight line segment connecting two neighboring corners of the cross-section. Herein, a “degree of sharpness” is defined as a percentage of “the length of the periphery of the cross-section” to the total length of all “sides of the cross-section”. For example, in a cross-section of a metal nanowire shown in FIG. 1, the degree of sharpness can be expressed as a percentage of the length of the periphery of the cross-section indicated by a solid curving line to the length of the periphery of a pentagon indicated by dotted straight line segments. The shape of a cross-section having a degree of sharpness of 75% or less is defined as the shape of the “cross-section having round corners”. The degree of the cross section is preferably 60% or less, more preferably 50% or less. When the degree of sharpness is more than 75%, the transparency may be degraded with a remaining yellowish color, likely because electrons are localized in the corners to enhance plasmon absorption.

A metal in the metal nanowires is not particularly limited, may be any metal, may be a single kind of metal or a combination of two or more kinds, and may be an alloy of metals. Among these, the metal in the metal nanowires is preferably formed from a metal or a metal compound, and more preferably formed from a metal.

The metal in the metal nanowires is preferably at least one metal selected from the group consisting of metals in the fourth period, the fifth period, and the sixth period of the long form of the periodic table (IUPAC1991), more preferably at least one metal selected from the group consisting of metals in the second to fourteenth group, still more preferably at least one metal selected from the group consisting of metals in the second family, the eighth family, the ninth family, the tenth family, the eleventh family, the twelfth family, the thirteenth family, and the fourteenth family; and particularly preferably these metal elements are used as main components.

Specific examples of the metal include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, and an alloy thereof. Among these, the metal is preferably copper, silver, gold, platinum, palladium, nickel, tin, cobalt, rhodium, iridium, or an alloy thereof, more preferably palladium, copper, silver, gold, platinum, tin, or an alloy thereof, particularly preferably silver or an alloy containing silver.

### (Method for Producing Metal Nanowires)

A method for producing metal nanowires according to the present invention is a method for producing the metal nanowires of the present invention, and includes adding a solution of a metal complex into a water solvent containing at least a halide and a reducing agent while heating the mixture at 150° C. or lower, and desalting if necessary.

The metal complex is not particularly limited, may be appropriately selected depending on the purpose, and is particularly preferably a silver complex. Examples of a ligand of the silver complex include CN⁻, SCN⁻, SO₃²⁻, thiourea, and ammonia. For these, refer to a description of T. H. James, “The Theory of the Photographic Process 4^{th} Edition” Macmillan Publishing. Among these, silver ammonia complex is particularly preferred.

The metal complex is preferably added after addition of a dispersant and a halide. Adding the metal complex in this way effectively increases the rate of the metal nanowires having a suitable diameter and length of the present invention, likely because wire nuclei may be highly likely to be formed.

The solvent is preferably a hydrophilic solvent; and examples of the hydrophilic solvent include water; alcohols such as methanol, ethanol, propanol, isopropanol, and butanol; ethers such as dioxane, and tetrahydrofuran; ketones such as acetone; and cyclic ethers such as tetrahydrofuran, and dioxane.

The temperature at which the mixture is heated is preferably 150° C. or lower, more preferably 20° C. to 130° C., still preferably 30° C. to 100° C., particularly preferably 40° C. to 90° C. If necessary, the temperature may be changed during the particle formation process, which may effectively control nucleation, or prevent renucleation, and improve monodispersity by enhancing selective growth.

When the heating temperature is higher than 150° C., the transmittance may be reduced in the evaluation of applied coat, likely because that corners of the cross-section of nanowires become very sharp. Furthermore, as the heating temperature decreases, dispersion stability may be degraded with easy tangling of metal nanowires, likely because that the metal nanowires become excessively long due to reduced probability of nucleation. In particular, this phenomenon is significantly observed at a temperature of 20° C. or lower.

Preferably, a reducing agent is contained in the mixture when heated. The reducing agent is not particularly limited, may be appropriately selected from those commonly used; examples thereof include a metal borohydride salt such as sodium borohydride, and potassium borohydride; an aluminum hydride salt such as lithium aluminum hydride, potassium aluminum hydride, cesium aluminum hydride, beryllium aluminum hydride, magnesium aluminum hydride, and calcium aluminum hydride; sodium sulfite; a hydrazine compound; a dextrin; hydroquinone; hydroxylamine; citric acid or a salt thereof, succinic acid or a salt thereof, ascorbic acid or a salt thereof; an alkanolamine such as diethylaminoethanol, ethanolamine, propanolamine, triethanolamine, and dimethylaminopropanol; an aliphatic amine such as propylamine, butylamine, dipropyleneamine, ethylenediamine, and triethylenepentamine; a heterocyclic amine such as piperidine, pyrrolidine, N-methylpyrrolidine, and morpholine; an aromatic amine such as aniline, N-methylaniline, toluidine, anisidine, and phenetidine; an aralkylamine such as benzylamine, xylenediamine, and N-methylbenzylamine; an alcohol such as methanol, ethanol, and 2-propanol; ethyleneglycol; glutathione; an organic acid such as citric acid, malic acid, and tartaric acid; a reducing sugar such as glucose, galactose, mannose, fructose, sucrose, maltose, raffinose, and stachyose; and a sugar alcohol such as sorbitol. Among these reducing agents, a reducing sugar and a sugar alcohol as a derivative of the reducing sugar are particularly preferred.

Some reducing agents may function also as a dispersant and may be used.

The reducing agent may be added before or after the addition of the dispersant, or before or after the addition of the halide.

Preferably, a halide is added in the production of the metal nanowires of the present invention.

The halide is not particularly limited and may be appropriately selected depending on the purpose as long as the halide is a compound containing bromine, chlorine, or iodine; examples thereof include an alkali halide such as sodium bromide, sodium chloride, sodium iodide, potassium iodide, potassium bromide, potassium chloride, and potassium iodide, and compounds which can be used in combination with the following dispersant. The halide may be added before or after the addition of the dispersant, or before or after the addition of the reducing agent. Some halide may function as a dispersant and this may also be used suitably.

As an alternative to the halide, metal halide fine particles may be used, or the metal halide fine particles may be used in combination with the halide.

Halides or metal halide fine particles that serve also as a dispersant may be used. Examples thereof include hexadecyl-trimethyl ammonium bromide (HTAB) which contains an amino group and bromide ion and hexadecyl-trimethyl ammonium chloride (HTAC) which contains an amino group and chloride ion.

Preferably, a dispersant is added in the production of the metal nanowires of the present invention.

The dispersant may be added before the preparation of the particles with the metal complex solution being added in the presence of a dispersant polymer, or added after the preparation of the particles so as to control the dispersion state. When the dispersant is added twice or more in a desired manner, the amount of the dispersant added in each time must be adjusted depending on the length of the wires desired. This may be because the length of the wires is varied by controlling the amount of metal particles used for the nucleation.

Examples of the dispersant include an amino-group containing compound, a thiol-group containing compound, a sulfide-group containing compound, an amino acid or a derivative thereof, a peptide compound, a polysaccharide, a natural polymer derived from the polysaccharide, a synthetic polymer, or polymers such as gel derived from these.

Examples of the polymer include a polymer having the properties of protective colloids such as gelatin, polyvinyl alcohol, methylcellulose, hydroxypropylcellulose, polyalkylene amine, a partial alkylester of polyacrylic acid, polyvinylpyrrolidone, and a polyvinylpyrrolidone copolymer.

The structure available for the dispersant may be referred to, for example, Seijiro Itoh Ed., “Ganryo no Jiten (Dictionary of Pigments)” (Asakura Publishing Co., Ltd., Tokyo, 2000).

The shape of the metal nanowires obtained can be varied by selecting the type of the dispersant used.

After the metal nanowires are formed, the desalting treatment can be carried out using such techniques as ultrafiltration, dialysis, gel filtration, decantation, and centrifugation.

### (Aqueous Dispersion)

An aqueous dispersion used in the present invention contains the metal nanowires of the present invention in a dispersion solvent.

The amount of the metal nanowires of the present invention in the aqueous dispersion is preferably 0.1% by mass to 99% by mass, and more preferably 0.3% by mass to 95% by mass. When the amount of the metal nanowires in the aqueous dispersion is less than 0.1% by mass, an excessive amount of load is applied on the metal nanowires in drying during the production process. When the amount of the metal nanowires in the aqueous dispersion is more than 99% by mass, particles may be readily aggregated.

The dispersion solvent for forming the aqueous dispersion is mostly water. Alternatively, the dispersion solvent may be a mixture of water and a water-miscible organic solvent in an amount of 80 vol. % or less.

The organic solvent is preferably an alcohol compound having a boiling point of 50° C. to 250° C., more preferably 55° C. to 200° C. When such an alcohol compound is used in combination with water, improvement of application of coat of the aqueous dispersion and reduction of amount of load in drying may be achieved.

The alcohol compound is not particularly limited and can be appropriately selected depending on the purpose. Examples thereof include methanol, ethanol, ethylene glycol, diethylene glycol, triethylene glycol, polyethylene glycol 200, polyethylene glycol 300, glycerin, propylene glycol, dipropylene glycol, 1,3-propanediol, 1,2-butanediol, 1,4-butanediol, 1,5-pentanediol, 1-ethoxy-2-propanol, ethanolamine, diethanolamine, 2-(2-aminoethoxy)ethanol and 2-dimethylaminoisopropanol. These may be used alone or in combination. Among them, ethanol and ethylene glycol are particularly preferred.

Preferably, the aqueous dispersion contains as little inorganic ions as possible (e.g. alkali metal ions, alkaline earth metal ions and halide ions).

The aqueous dispersion has an electrical conductivity of preferably 1 mS/cm or less, more preferably 0.1 mS/cm or less, still more preferably 0.05 mS/cm or less.

The aqueous dispersion has a viscosity at 20° C. of preferably 0.5 mPa·s to 100 mPa·s, and more preferably 1 mPa·s to 50 mPa·s.

If necessary, the aqueous dispersion may contain various additives such as a surfactant, a polymerizable compound, an antioxidant, an anti sulfurizing agent, a rust retardant, a viscosity adjuster, and a preservative.

The rust retardant is not particularly limited, can be appropriately selected depending on the purpose, and is preferably one of azoles. Examples of the azoles include at least one selected from the group consisting of benzotriazole, tolyltriazole, mercaptobenzothiazole, mercaptobenzotriazole, mercaptobenzotetrazole, (2-benzothiazolylthio) acetic acid, 3-(2-benzothiazolylthio) propionic acid, and an alkali metal salt thereof, an ammonium salt thereat and an amine salt thereof. A more excellent rust-retarding effect can be expected to occur in the aqueous dispersion containing the rust retardant. The rust retardant may be directly added into the aqueous dispersion as a solution in an appropriate solvent or as a powder, or may be provided for a transparent conductor described below, after it has been produced, by dipping the transparent conductor in a bath of a solution of the rust retardant.

The aqueous dispersion may be suitably used as an aqueous ink for an inkjet printer or dispenser.

A substrate, on which the aqueous dispersion is applied in image formation by an inkjet printer, includes, for example, paper, coated paper, and a PET film whose surface is coated with, for example, a hydrophilic polymer.

### (Transparent Conductor)

A transparent conductor according to the present invention contains a transparent conductive layer formed by the aqueous dispersion.

The transparent conductor is produced by applying the aqueous dispersion of the present invention on a substrate and drying the aqueous dispersion.

Details of the transparent conductor of the present invention are specified below through the description of a method for producing the transparent conductor.

The substrate on which the aqueous dispersion is applied is not particularly limited and can be appropriately selected depending on the purpose. Examples of the substrate for a transparent conductor include the following. Among them, a polymer film is preferred, and a PET film, a TAC film, and a PEN film are particularly preferred in terms of production suitability, lightweight properties, flexibility, and optical properties (polarization properties).

(1) glass such as quartz glass, alkali-free glass, transparent crystallized glass, PYREX (registered trademark) glass, and sapphire,

(2) acrylic resins such as polycarbonate and polymethyl methacrylate; vinyl chloride resins such as polyvinyl chloride and vinyl chloride copolymers; and thermoplastic resins such as polyarylate, polysulfone, polyethersulfone, polyimide, PET, PEN, fluorine resins, phenoxy resins, polyolefine resins, nylon, styrene resins and ABS resins, and

(3) thermosetting resins such as epoxy resins.

As desired, the above-mentioned substrates may be used in combination. Using substrates appropriately selected from the above depending on the intended application, a flexible or rigid substrate having a shape of film, etc. can be formed.

The substrate may have any shape such as a disc shape, a card shape or a sheet shape. Also, the substrate may have a three-dimensionally laminated structure. Further, the substrate may have fine pores or grooves with aspect ratios of 1 or more in a portion where the printed wiring is formed, and the aqueous dispersion of the present invention may be discharged thereinto using an inkjet printer or dispenser.

The substrate is preferably treated to be given hydrophilicity to the surface thereof. Also, a hydrophilic polymer is preferably applied on the substrate surface. Such treatments allow the aqueous dispersion to be readily applied on the substrate with improved adhesion.

The above hydrophilication treatment is not particularly limited and can be appropriately selected depending on the purpose. The hydrophilication treatment employs, for example, chemicals, mechanical roughening, corona discharge, flames, UV rays, glow discharge, active plasma or laser beams. Preferably, the surface tension of the substrate surface is adjusted to 30 dyne/cm or more through this hydrophilication treatment.

The hydrophilic polymer which is applied on the substrate surface is not particularly limited and can be appropriately selected depending on the purpose. Examples thereof include gelatin, gelatin derivatives, casein, agar, starch, polyvinyl alcohol, polyacrylic acid copolymers, carboxymethyl cellulose, hydroxyethyl cellulose, polyvinylpyrrolidone, and dextran.

The thickness of the hydrophilic polymer layer is preferably 0.001 μm to 100 μm, and more preferably 0.01 μm to 20 μm (in a dried state).

Preferably, a hardener is incorporated into the hydrophilic polymer layer to increase its film strength. The hardener is not particularly limited and can be appropriately selected depending on the purpose. Examples thereof include aldehyde compounds such as formaldehyde and glutaraldehyde; ketone compounds such as diacetyl ketone and cyclopentanedione; vinylsulfone compounds such as divinylsulfone; triazine compounds such as 2-hydroxy-4,6-dichloro-1,3,5-triazine; and isocyanate compounds described in, for example, U.S. Pat. No. 3,103,437.

The hydrophilic polymer layer can be formed as follows: the above hydrophilic compound is dissolved or dispersed in an appropriate solvent (e.g., water) to prepare a coating liquid; using a coating method such as spin coating, dip coating, extrusion coating, bar coating or die coating, the thus-prepared coating liquid is applied on a substrate surface which had undergone a hydrophilication treatment; and the coated substrate is dried. The temperature at which the hydrophilic polymer is dried is preferably 120° C. or less, more preferably 30° C. to 100° C., and still more preferably 40° C. to 80° C.

If necessary, an undercoat layer may be provided between the substrate and the hydrophilic polymer layer for improving adhesiveness therebetween.

In the present invention, the formed transparent conductor is preferably dipped in a bath of a solution of a rust retardant, and thereby given a more excellent rust-retarding effect.

### —Application of Use—

The transparent conductor of the present invention will be widely used in, for example, touch panels, antistatic film for displays, electromagnetic shielding materials, electrodes for organic or inorganic EL displays, other kinds of electrodes or antistatic materials for flexible displays, electrodes for solar batteries, E-paper, electrodes for flexible displays, antistatic film for flexible displays, electrodes for solar batteries, and various other devices.

### EXAMPLES

The present invention will next be described by way of examples, which should not be construed as limiting the present invention thereto.

In the following Examples, “the diameter of metal nanowires”, “the major axis length of metal nanowires”, “the coefficient of variation of the diameter of metal nanowires”, “the rate of suitable wires”, and “the degree of sharpness of corners of the cross-section of metal nanowires” were measured as follows.

### <Diameter and Major Axis Length of Metal Nanowires>

The diameter and the major axis length of the metal nanowires were, respectively, a mean of diameters and a mean of major axis lengths of 300 metal nanowires observed under a transmission electron microscope (TEM; JEM-2000FX, manufactured by JEOL Ltd.).

### <Coefficient of Variation of Diameter of Metal Nanowires>

The coefficient of variation of diameter of the metal nanowires was determined by calculating from the standard deviation and the mean of diameters of 300 metal nanowires measured using a transmission electron microscope (TEM; JEM-2000FX, manufactured by JEOL Ltd.).

### <Rate of Suitable Wires>

The suitable silver nanowires in a water dispersion of the silver nanowires were separated through filtration from the other particles than the suitable wires, and the amount of Ag remaining on the paper filter and the amount of Ag in the filtrate were each measured by means of an ICP atomic emission spectrometer (ICPS-8000, manufactured by Shimadzu Corporation). The amount of silver nanowires having a diameter of 50 nm or less and a major axis length of 5 μm or more (the suitable wires) in the total metal particles were determined in terms of metal amount (% by mass).

In order to determine the rate of suitable wires, the separation of the suitable silver nanowires was carried out using a membrane filter (FALP 02500, manufactured by Millipore Corporation; pore diameter: 1.0 μm).

### <Degree of Sharpness of Cross-Section's Corners of Metal Nanowires>

As to the shape of the cross section of the metal nanowires, the degree of sharpness, which is defined as a percentage of “the length of the periphery of the cross-section” to the total length of all “sides of the cross-section”, was determined as follows. Specifically, a water dispersion of the metal nanowires was applied on a substrate, and 300 cross-sections were observed through a transmission electron microscope (TEM; JEM-2000FX, manufactured by JEOL Ltd.) for measuring the length of the periphery and the total length of all sides of the cross-section. The shape of a cross-section having a degree of sharpness of 75% or less is defined as the shape of the “cross-section having round corners”.

### Production Example 1

### Preparation of Additive Liquid A

Silver nitrate powder (0.51 g) was dissolved in 50 mL of pure water. Subsequently, ammonia water (1 N) was added until the mixture became transparent, and then pure water was added such that the total volume reached 100 mL.

### Production Example 2

### Preparation of Additive Liquid G

Glucose powder (0.5 g) was dissolved in 140 mL of pure water to prepare an additive liquid G.

### Production Example 3

### Preparation of Additive Liquid H

Hexadecyl-trimethylammonium bromide (HTAB) powder (0.5 g) was dissolved in 27.5 mL of pure water to prepare an additive liquid H.

### Example 1

### Production of Silver Nanowire Water Dispersion of Sample 101

Pure water (410 mL), 82.5 mL of the additive liquid H, and 206 mL of the additive liquid G were added, using a funnel, into a three-necked flask at 20° C. while stirring (the first step). Into this mixture, 206 mL of the additive liquid A was added at a flow rate of 2.0 mL/min and at a stirrer rotational speed of 800 rpm (the second stage). Ten minutes after, 82.5 mL of the additive liquid H was added. Subsequently, the temperature of the mixture was increased to an internal temperature of 75° C. at an increasing rate of 3° C./min. Then, the stirrer rotational speed was decreased to 200 rpm and the mixture was heated for 5 hr.

After the thus obtained water dispersion had been cooled, an ultrafiltration apparatus was assembled by connecting an ultrafiltration module SIP1013 (manufactured by Asahi Kasei Corporation, molecular weight cut off: 6,000), a magnetic pump, and a stainless cup by means of silicon tubes. The silver nanowire dispersion (aqueous solution) was poured into the stainless cup, and subjected to ultrafiltration by allowing the pump to operate. When the volume of the filtrate from the module became 50 mL, 950 mL of distilled water was added into the stainless cup, and the filtered matter was washed. After the above washing had been repeated ten times, the filtered matter was concentrated until the volume of the mother liquor became 50 mL.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 101 thus obtained.

### Example 2

### Production of Silver Nanowire Water Dispersion of Sample 102

The silver nanowire water dispersion of sample 102 was produced in the same manner as in Example 1 except that the initial temperature of the mixture solution in the first stage was changed from 20° C. to 25° C.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 102 thus obtained.

### Example 3

### Production of Silver Nanowire Water Dispersion of Sample 103

The silver nanowire water dispersion of sample 103 was produced in the same manner as in Example 1 except that the initial temperature of the mixture solution in the first stage was changed from 20° C. to 30° C.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 103 thus obtained.

### Example 4

### Production of Silver Nanowire Water Dispersion of Sample 104

The silver nanowire water dispersion of sample 104 was produced in the same manner as in Example 1 except that the amount of the additive liquid H added in the first stage was changed from 82.5 mL to 70.0 mL.

Table 1-1 shows the diameter of the silver nanowires, the major axis length of the silver nanowires, the rate of suitable wires, the coefficient of variation of diameter of the silver nanowires, and the degree of sharpness of cross-section's corners of the sample 104 thus obtained.

### Example 5

### Production of Silver Nanowire Water Dispersion of Sample 105

The silver nanowire water dispersion of sample 105 was produced in the same manner as in Example 1 except that the amount of the additive liquid H added in the first stage was changed from 82.5 mL to 65.0 mL.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 105 thus obtained.

### Example 6

### Production of Silver Nanowire Water Dispersion of Sample 106

The silver nanowire water dispersion of sample 106 was produced in the same manner as in Example 1 except that the addition flow rate of the additive liquid A was changed from 2.0 mL/min to 4.0 in mL/min.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 106 thus obtained.

### Example 7

### Production of Silver Nanowire Water Dispersion of Sample 107

The silver nanowire water dispersion of sample 107 was produced in the same manner as in Example 1 except that the addition flow rate of the additive liquid A was changed from 2.0 mL/min to 6.0 mL/min.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 107 thus obtained.

### Example 8

### Production of Silver Nanowire Water Dispersion of Sample 108

The silver nanowire water dispersion of sample 108 was produced in the same manner as in Example 1 except that the temperature in the second stage was increased from 75° C. at an increasing rate of 1.5° C./hr.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 108 thus obtained.

### Example 9

### Production of Silver Nanowire Water Dispersion of Sample 109

The silver nanowire water dispersion of sample 109 was produced in the same manner as in Example 1 except that the temperature in the second stage was increased from 75° C. at an increasing rate of 2.5° C./hr.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 109 thus obtained.

### Example 10

### Production of Silver Nanowire Water Dispersion of Sample 110

The silver nanowire water dispersion of sample 110 was produced in the same manner as in Example 1 except that the temperature in the second stage was kept at 80° C.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 110 thus obtained.

### Example 11

### Production of Silver Nanowire Water Dispersion of Sample 111

The silver nanowire water dispersion of sample 111 was produced in the same manner as in Example 1 except that the temperature in the second stage was kept at 90° C.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 111 thus obtained.

### Example 12

### Production of Silver Nanowire Water Dispersion of Sample 112

The silver nanowire water dispersion of sample 112 was produced in the same manner as in Example 1 except that the temperature in the second stage was increased from 75° C. at an increasing rate of 3.5° C./hr.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 112 thus obtained.

### Example 13

### Production of Silver Nanowire Water Dispersion of Sample 113

The silver nanowire water dispersion of sample 113 was produced in the same manner as in Example 1 except that the temperature in the second stage was kept at 95° C.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 113 thus obtained.

### Comparative Example 1

### Production of Silver Nanowire Water Dispersion of Sample 201

The silver nanowire water dispersion of sample 201 was produced in the same manner as in Example 1 except that the initial temperature of the mixture solution in the first stage was changed from 20° C. to 40° C.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 201 thus obtained.

### Comparative Example 2

### Production of Silver Nanowire Water Dispersion of Sample 202

The silver nanowire water dispersion of sample 202 was produced in the same manner as in Example 1 except that the amount of the additive liquid H added in the first stage was changed from 82.5 mL to 50.0 mL.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 202 thus obtained.

### Comparative Example 3

### Production of Silver Nanowire Water Dispersion of Sample 203

The silver nanowire water dispersion of sample 203 was produced in the same manner as in Example 1 except that the addition flow rate of the additive liquid A was changed from 2.0 mL/min to 8.0 mL/min.

Table 1-1 shows the diameter of the silver nanowires, the major axis length of the silver nanowires, the rate of suitable wires, the coefficient of variation of diameter of the silver nanowires, and the degree of sharpness of cross-section's corners of the silver nanowires of the sample 203 thus obtained.

Water was added to each silver nanowire water dispersion thus obtained, and the dilution was centrifuged and purified until the conductivity reached 50 μS/cm or less, to thereby prepare a coating water dispersion in which the amount of silver is adjusted to 22% by mass in the dispersion. All of these coating water dispersions were found to have a viscosity of 10 mPa·s (25° C.) or lower. For all samples a diffraction pattern of metal silver was obtained for all samples by XRD measurement (RINT2500, manufactured by Rigaku Corporation).

Subsequently, a commercially available, biaxially-oriented heat set polyethylene terephthalate (PET) substrate (thickness: 100 μm) was treated by corona discharge at 8 W/m²·min. The composition of the undercoat layer is given below. Then, an undercoat layer was formed on the thus-treated substrate such that the dry thickness of the undercoat layer became 0.8 μm.

### —Composition of Undercoat Layer—

The undercoat layer contains a copolymer latex composed of butylacrylate (40% by mass), styrene (20% by mass), and glycidyl acrylate (40% by mass), and 0.5% by mass of hexamethylene-1,6-bis(ethyleneurea).

Subsequently, the surface of the undercoat layer was treated by corona discharge of 8 W/m²·min and coated with hydroxyethyl cellulose for forming a hydrophilic polymer layer such that the dry thickness of the hydroxyethyl cellulose layer became 0.2 μm.

Subsequently, each coating water dispersion of the samples 101 to 113 and the samples 201 to 203 was applied on the hydrophilic polymer layer using Doctor coater, and then dried. The amount of coated silver was measured by an X-ray fluorescence spectrometer (SEA1100, manufactured by Seiko Instruments Inc.), and the amount of the coating water dispersion was adjusted such that the amount of coated silver became 0.02 g/m².

Next, various characteristics were evaluated for each applied coat thus obtained as follows. The results are shown in Table 1-2.

### <Transmittance of Initial Applied Coat>

The transmittance of each applied coat thus obtained was measured using UV-2550 (manufactured by Shimadzu Corporation) at 400 nm to 800 nm.

### [Evaluation Criteria]

A: Transmittance was 90% or more, no problem in practical use

B: Transmittance was 80% or more and less than 90%, no problem in practical use

C: Transmittance was 75% or more and less than 80%, no problem in practical use

D: Transmittance was 0% or more and less than 75%, problematic in practical use

### <Surface Resistance (Conductivity) of Initial Applied Coat>

The surface resistance of each applied coat thus obtained was measured using Loresta-GP MCP-T600 (manufactured by Mitsubishi Chemical Corporation), and the conductivity was evaluated according to the following criteria.

### [Evaluation Criteria]

A: Surface resistance was less than 100 ohms/square, no problem in practical use

B: Surface resistance was less than 500 ohms/square, no problem in practical use

C: Surface resistance was less than 1,000 ohms/square, no problem in practical use

D: Surface resistance was 1,000 ohms/square or more, problematic in practical use

### <Test for Durability of Applied Coat>

An applied coat sample was produced in the same manner as mentioned above, using each water dispersion of the samples 101 to 113 and the samples 201 to 203. The sample applied coats were left in an atmosphere of 50° C. and an RH of 60% for two weeks, and then the applied coats were compared one another with respect to storage stability, by measuring the surface resistance and the transmittance of the applied coats after the lapse of time.

TABLE 1-1

| | Diameter | Major axis | Rate of suitable wires | Coefficient of variation | Degree of sharpness of cross- |
|---|---|---|---|---|---|
| Sample | (nm) | length (μm) | (% by mass) | of diameter (%) | section's corners (%) |
| 101 | 17.6 | 36.7 | 82.6 | 18.3 | 47.3 |
| 102 | 23.8 | 41.8 | 78.3 | 29.3 | 37.3 |
| 103 | 48.3 | 32.3 | 62.7 | 33.4 | 43.4 |
| 104 | 16.2 | 13.7 | 76.3 | 22.3 | 48.1 |
| 105 | 17.8 | 6.8 | 63.2 | 27.4 | 58.3 |
| 106 | 19.4 | 41.8 | 71.7 | 24.3 | 45.3 |
| 107 | 16.3 | 32.4 | 58.4 | 28.4 | 49.2 |
| 108 | 19.2 | 37.5 | 78.3 | 33.7 | 42.3 |
| 109 | 18.3 | 34.2 | 67.3 | 38.2 | 47.2 |
| 110 | 16.3 | 28.3 | 77.2 | 22.7 | 57.4 |
| 111 | 18.2 | 26.3 | 62.7 | 31.2 | 68.3 |
| 112 | 16.3 | 12.7 | 58.2 | 45.4 | 46.1 |
| 113 | 18.2 | 23.4 | 77.6 | 38.1 | 89.4 |
| 201 | 62.4 | 34.6 | 68.4 | 43.4 | 32.7 |
| 202 | 18.2 | 3.7 | 54.2 | 27.4 | 37.2 |
| 203 | 19.2 | 13.2 | 28.3 | 38.1 | 43.2 |

TABLE 1-2

| | | | | After test period | |
|---|---|---|---|---|---|
| | | Initial | | of durability | |
| | | Trans- | Conduc- | Trans- | Conduc- |
| | Sample | parency | tivity | parency | tivity |
| Ex. 1 | 101 | A | A | A | A |
| Ex. 2 | 102 | A | A | A | A |
| Ex. 3 | 103 | B | A | B | A |
| Ex. 4 | 104 | A | B | A | B |
| Ex. 5 | 105 | A | B | A | C |
| Ex. 6 | 106 | B | B | B | B |
| Ex. 7 | 107 | B | B | B | C |
| Ex. 8 | 108 | A | A | A | B |
| Ex. 9 | 109 | A | A | B | C |
| Ex. 10 | 110 | B | A | B | A |
| Ex. 11 | 111 | C | A | C | B |
| Ex. 12 | 112 | B | A | C | C |
| Ex. 13 | 113 | C | B | C | C |
| Comp. Ex. 1 | 201 | D | A | D | B |
| Comp. Ex. 2 | 202 | B | D | C | D |
| Comp. Ex. 3 | 203 | D | D | D | D |

The metal nanowires and their aqueous dispersion of the present invention will be widely used in, for example, touch panels, antistatic film for displays, electromagnetic shielding materials, electrodes for organic or inorganic EL displays, E-paper, electrodes for flexible displays, antistatic film for flexible displays, electrodes for solar batteries, and various other devices.

What is claimed is:

1. Metal nanowires comprising:
metal nanowires having a diameter of 50 nm or less and a major axis length of 5 μm or more in an amount of 50% by mass or more in terms of metal amount with respect to total metal particles.

2. The metal nanowires according to claim 1, wherein the coefficient of variation of diameter of the metal nanowires is 40% or less.

3. The metal nanowires according to claim 1, wherein a cross-section of each of the metal nanowire has round corners.

4. The metal nanowires according to claim 1, wherein the metal nanowires contain silver.

5. A method for producing metal nanowires, comprising:
adding a solution of a metal complex to a water solvent containing at least a 1.5 halide and a reducing agent, and
heating a resultant mixture at 150° C. or lower,
wherein the metal nanowires comprise metal nanowires having a diameter of 50 nm or less and a major axis length of 5 μm or more in an amount of 50% by mass or more in terms of metal amount with respect to total metal particles.

6. A transparent conductor comprising:
a transparent conductive layer,
wherein the transparent conductive layer contains metal nanowires which comprise metal nanowires having a diameter of 50 nm or less and a major axis length of 5 μm or more in an amount of 50% by mass or more in terms of metal amount with respect to total metal particles.

7. The transparent conductor according to claim 6, wherein the transparent conductor is used in one of a touch panel and a solar battery panel.
